(19) United States
(12) Patent Application Publication
(10) Pub. No.: US 2026/0156547 A1
(43) Pub. Date: Jun. 4, 2026

(54) ENHANCEMENT ON NETWORK CONTROLLED SMALL GAP (NCSG) SUPPORT

(71) Applicant: APPLE INC., Cupertino, CA (US)

(72) Inventors: Qiming Li, Beijing (CN); Yang Tang, San Jose, CA (US); Jie Cui, San Jose, CA (US); Dawei Zhang, Saratoga, CA (US); Manasa Raghavan, Sunnyvale, CA (US); Yuqin Chen, Beijing (CN); Yuexia Song, Beijing (CN); Xiang Chen, Campbell, CA (US); Rolando E Bettancourt Ortega, Munich (DE)

(21) Appl. No.: 19/122,579

(22) PCT Filed: Nov. 3, 2022
(86) PCT No.: PCT/CN2022/129564

§ 371 Date: Apr. 18, 2025

(51) Int. Cl. H04W 36/00

(52) U.S. Cl. CPC H04W 36/0088

(57) ABSTRACT

Enhancement on Network Controlled Small Gap (NCSG) support is disclosed. A network device may be configured to receive NCSG support information from a user equipment (UE), the NCSG support information at least comprising a first support indicator for a target band; determine, based on a specified condition, a NCSG configuration for the UE from: a first NCSG configuration that is based on the first support indicator; or a second NCSG configuration that is different from the first NCSG configuration; transmit the determined NCSG configuration to the UE; and perform a measurement object with the UE based on the determined NCSG configuration.

### TECHNICAL FIELD

This application relates generally to wireless communication systems, including methods, devices and systems for enhancement on Network Controlled Small Gap (NCSG) support.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

### SUMMARY

One aspect of the disclosure provides a network device, comprising: at least one antenna; at least one radio coupled to the at least one antenna; and a processor coupled to the at least one radio; wherein the processor is configured to: receive NCSG support information from a UE, the NCSG support information at least comprising a first support indicator for a target band; determine, based on a specified condition, a NCSG configuration for the UE from: a first NCSG configuration that is based on the first support indicator; or a second NCSG configuration that is different from the first NCSG configuration; transmit the determined NCSG configuration to the UE; and perform a measurement object (MO) with the UE based on the determined NCSG configuration.

Another aspect of the disclosure provides a UE, comprising: at least one antenna; at least one radio coupled to the at least one antenna; and a processor coupled to the at least one radio; wherein the processor is configured to: report NCSG support information to a network device, the NCSG support information at least comprising a first support indicator of the UE for a target band, the NCSG support information further comprising additional information associated with a specified condition; receive NCSG configuration from the network device, the NCSG configuration is selected from: a first NCSG configuration based on the reported first support indicator; or a second NCSG configuration different from the first NCSG configuration; and perform a measurement object based on the received NCSG configuration.

Another aspect of the disclosure provides a method of a network device, comprising: receiving NCSG support information from a UE, the NCSG support information at least comprising a first support indicator for a target band; determining, based on a specified condition, a NCSG configuration for the UE from: a first NCSG configuration that is based on the first support indicator; or a second NCSG configuration that is different from the first NCSG configuration; transmitting the determined NCSG configuration to the UE; and performing a measurement object with the UE based on the determined NCSG configuration.

Another aspect of the disclosure provides a method of a UE, comprising: reporting NCSG support information to a network device, the NCSG support information at least comprising a first support indicator of the UE for a target band, the NCSG support information further comprising additional information associated with a specified condition; receiving NCSG configuration from the network device, the NCSG configuration being selected from: a first NCSG configuration based on the reported first support indicator; or a second NCSG configuration different from the first NCSG configuration; and performing a measurement object based on the received NCSG configuration.

Another aspect of the disclosure provides a computer-readable medium comprising instructions that when executed by a processor of a network device, cause the processor to perform any method disclosed herein for the network device.

Another aspect of the disclosure provides a computer-readable medium comprising instructions that when executed by a processor of a UE, cause the processor to perform any method disclosed herein for the UE.

Another aspect of the disclosure provides a computer program product comprising programs that when executed by a processor of a network device, cause the processor to perform any method disclosed herein for the network device.

Another aspect of the disclosure provides a computer program product comprising programs that when executed by a processor of a UE, cause the processor to perform any method disclosed herein for the UE.

Another aspect of the disclosure provides an apparatus comprising means for performing any method disclosed herein for a network device.

Another aspect of the disclosure provides an apparatus comprising means for performing any method disclosed herein for a UE.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an exemplary process associated with configuration and use of NCSG, according to embodiments disclosed herein.

FIGS. 4A-4C illustrates exemplary types of NCSG modes according to embodiments disclosed herein.

FIG. 5 illustrates an exemplary process that implements enhancement on NCSG support according to embodiments disclosed herein.

FIG. 6 illustrates an exemplary process that implements enhancement on NCSG support according to embodiments disclosed herein.

FIGS. 7A-7B illustrates exemplary scenarios in which a maximum number of activated Secondary Cells (SCells) is specified according to embodiments disclosed herein.

FIG. 8 illustrates an exemplary scenario in which a particular indication of NCSG support per bandwidth part (BWP) is used according to embodiments disclosed herein.

### DETAILED DESCRIPTION

NCSG may be used by a wireless communication system to, for example, enhance the signal measurement processes by which a UE performs intra-frequency measurements and/or inter-frequency measurements.

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

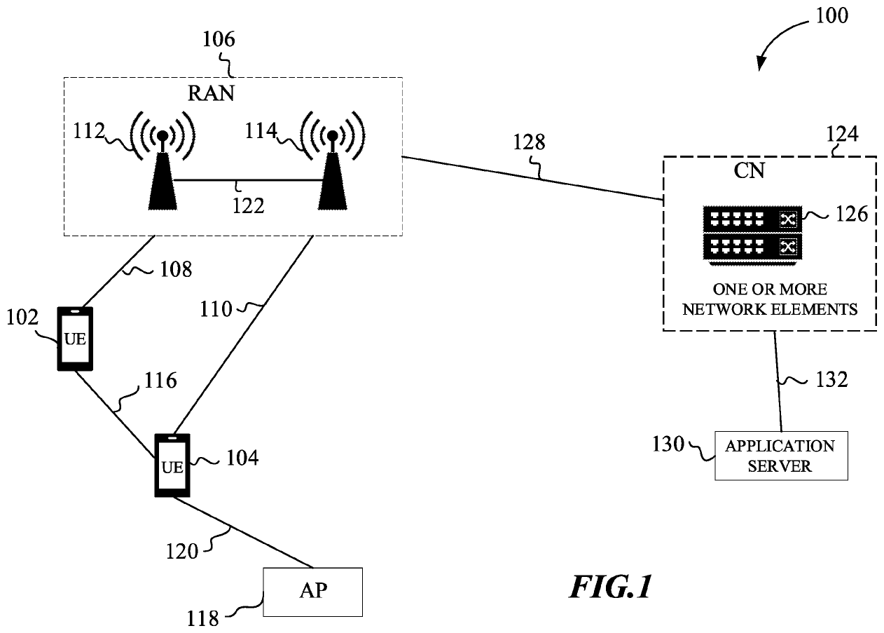

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

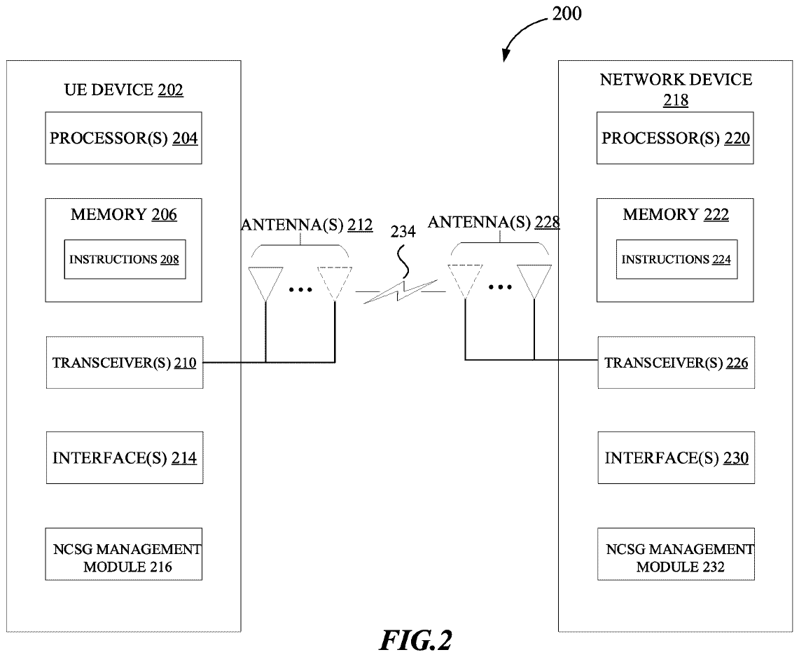

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The wireless device 202 may include a NCSG management module 216. The NCSG management module 216 may be implemented via hardware, software, or combinations thereof. For example, the NCSG management module 216 may be implemented as a processor, circuit, and/or instructions 208 stored in the memory 206 and executed by the processor(s) 204. In some examples, the NCSG management module 216 may be integrated within the processor(s) 204 and/or the transceiver(s) 210. For example, the NCSG management module 216 may be implemented by a combination of software components (e.g., executed by a DSP or a general processor) and hardware components (e.g., logic gates and circuitry) within the processor(s) 204 or the transceiver(s) 210.

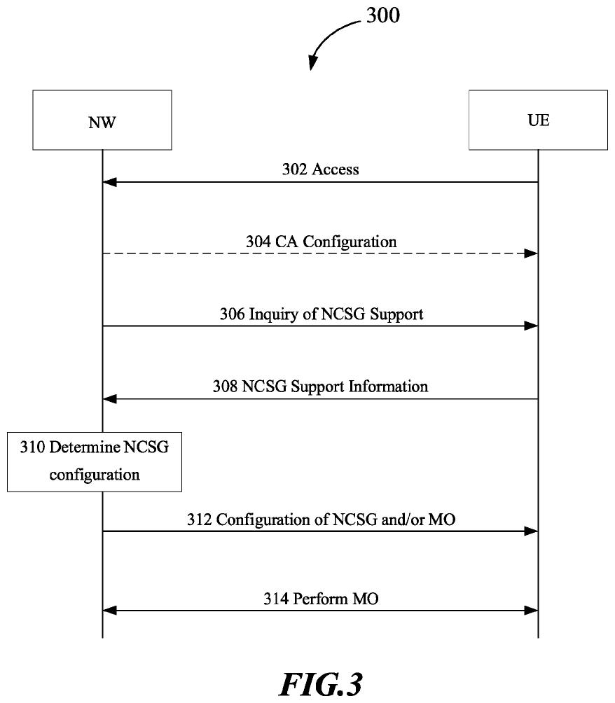

The NCSG management module 216 may be used for various aspects of the present disclosure, for example, aspects of FIGS. 3-8. The NCSG management module 216 is configured to report NCSG support information to a network device, the NCSG support information at least comprising a first support indicator of the wireless device 202 for a target band, the NCSG support information further comprising additional information associated with a specified condition; receive NCSG configuration from the network device, the NCSG configuration is selected from: a first NCSG configuration based on the reported first support indicator; or a second NCSG configuration different from the first NCSG configuration; and perform a measurement object based on the received NCSG configuration.

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

The network device 218 may include a NCSG management module 232. The NCSG management module 232 may be implemented via hardware, software, or combinations thereof. For example, the NCSG management module 232 may be implemented as a processor, circuit, and/or instructions 224 stored in the memory 222 and executed by the processor(s) 220. In some examples, the NCSG management module 232 may be integrated within the processor(s) 220 and/or the transceiver(s) 226. For example, the NCSG management module 232 may be implemented by a combination of software components (e.g., executed by a DSP or a general processor) and hardware components (e.g., logic gates and circuitry) within the processor(s) 220 or the transceiver(s) 226.

The NCSG management module 232 may be used for various aspects of the present disclosure, for example, aspects of FIGS. 3-8. The NCSG management module 232 is configured to receive NCSG support information from a UE, the NCSG support information at least comprising a first support indicator for a target band; determine, based on a specified condition, a NCSG configuration for the UE from: a first NCSG configuration that is based on the first support indicator; or a second NCSG configuration that is different from the first NCSG configuration; transmit the determined NCSG configuration to the UE; and perform a measurement object with the UE based on the determined NCSG configuration.

FIG. 3 illustrates an exemplary process 300 associated with configuration and use of NCSG, according to embodiments disclosed herein. The process 300 may be performed by a network device (NW) and a UE. The network device may be implemented as an instance of the network device 218 of FIG. 2. The UE may be implemented as an instance of the wireless device 202 of FIG. 2.

The process 300 may start at step 302, in which the UE may start access to the network device. For example, the UE may establish one or more connections with the network device when entering a cell served by the network device. The network device may represent a collection of devices associated with the cell, such as devices used for the Primary Cell (PCell) and Secondary Cells (SCells). The connections may be based on one or more RF chains. Some types of UE can only support a single RF chain with the network device, while other types of UE may be able to support multiple RF chains with the network device.

Additionally, the UE may indicate its support of NCSG functionality after it has access to the network device. For example, the UE may report if it generally supports NCSG functionality. The indication may be carried in one or more capability report messages from the UE to the network device.

At step 304, the network device may provide a carrier aggregation (CA) configuration to the UE. The CA configuration may be designated by the network device. For example, the UE may be able to support three frequency bands (such as band A, band B and band C). The network device may designate a CA configuration of band A and band B for the UE to transmit and/or receive data packets (such as multi-media data packets) with the network device. Other CA configurations may also be applicable. Note that step 304 is optional, so it is illustrated with a dash-dotted arrow.

At step 306, the network device may send an inquiry of NCSG support of the UE for one or more target bands. The inquiry of NCSG support may be directed to any target band selected from band A, band B and/or band C, or other target bands (for example, band D, band E or other bands) that may be of interest by the network device. In some embodiments, the inquiry of NCSG support may be sent when measurement on the target band may be needed. Before use of the target band, the network device may need to know whether the UE is able to perform the measurement on the target band without interrupting data transmission on current operating bands (such as band A and band B) of the designated CA configuration. In other words, the network device may need to know the UE's NCSG support (or, preferred NCSG mode) for the target band.

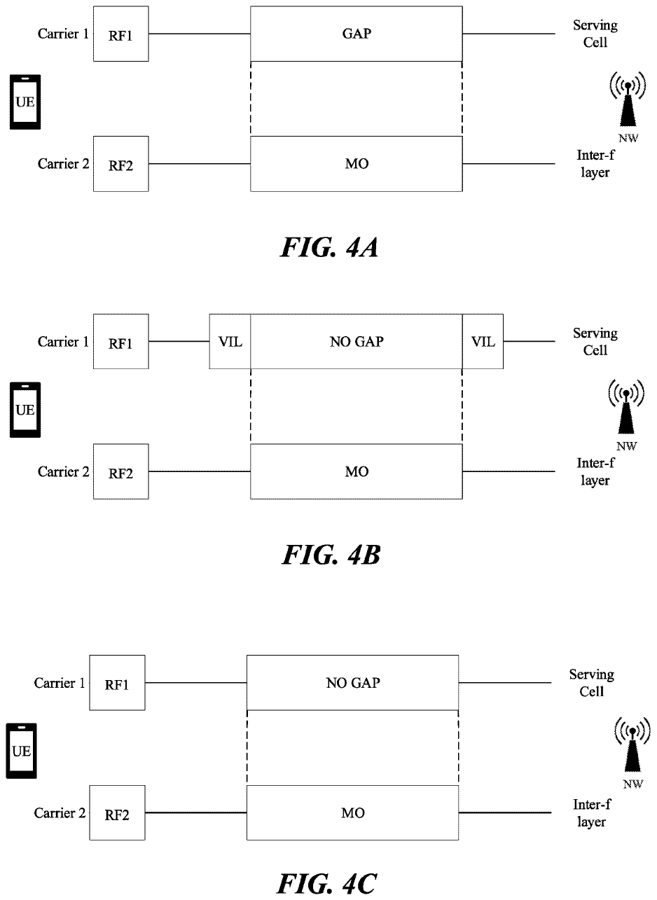

At step 308, in response to the received inquiry, the UE may report NCSG support information associated with the one or more target bands. The NCSG support information may indicate a NCSG mode of the UE for each target band. The UE may use a respective support indicator to represent a respective NCSG mode. Exemplary NCSG modes may corresponds to the NCSG modes illustrated in FIGS. 4A-4C. According to some embodiments disclosed herein, the UE may specify respective support indicator(s) for each target band and include the specified support indicator(s) in the NCSG support information. The respective support indicator may be specified at least based on the CA configuration designated for the UE. For example, the fact that the UE is configured with a CA of band A and band B might affect the UE's NCSG mode for the band A or the band B as a target band.

An exemplary NCSG support information element is illustrated in Table 1. Note that the NCSG support information elements discussed in the disclosure are merely for illustrative purpose. Alternative NCSG support information element may also be applicable. If desired, the NCSG support information elements may be applicable to any wireless system implementing any suitable communication protocols and/or standards, including but not limited to 5G standards and any future standards.

TABLE 1
NCSG support information element

NeedForGapNCSG-InfoNR-r17 :: = SEQUENCE {

| | |
|---|---|
| intraFreq-needForNCSG-r17 | NeedForNCSG-IntraFreqList-r17, |
| interFreq-needForNCSG-r17 | NeedForNCSG-BandListNR-r17 |

}
NeedForNCSG-IntraFreqList-r17 :: = SEQUENCE (SIZE (1..
maxNrofServingCells)) OF NeedForNCSG-IntraFreq-r17
NeedForNCSG-BandListNR-r17 :: = SEQUENCE (SIZE (1..maxBands)) OF
NeedForNCSG-NR-r17
NeedForNCSG-IntraFreq-r17 :: = SEQUENCE {

| | |
|---|---|
| servCellId-r17 | ServCellIndex, |
| gapIndicationIntra-r17 | ENUMERATED {gap, ncsg, nogap-noncsg} |

}

| | |
|---|---|
| NeedForNCSG-NR-r17 :: = | SEQUENCE { |
| bandNR-r17 | FreqBandIndicatorNR, |
| gapIndication-r17 | ENUMERATED {gap, ncsg, nogap-noncsg} |

}

As shown in the table, the NCSG support information element may include an intra-band support indicator (e.g., in intraFreq-needForNCSG-r17) and/or an inter-band support indicator (e.g., in interFreq-needForNCSG-r17). The intra-band support indicator may be provided per serving cell (e.g., per ServCellIndex). The inter-band support indicator may be provided per frequency band (e.g., per FreqBandIndicatorNR). According to embodiments disclosed herein, the NCSG support information element may include one or more additional information (not illustrated in Table 1) that may facilitate enhancement on NCSG support, which will be discussed with more details hereinafter.

Each support indicator of the NCSG support information element may have a value that is selected from a set of enumerated values of {gap, ncsg, nogap-noncsg}. Each of these values may correspond to a respective NCSG mode illustrated in FIGS. 4A-4C.

FIG. 4A illustrates a first type of NCSG mode according to embodiments disclosed herein. In this example, two RF chains (shown as the RF1 and RF2 chains) are shown, each RF chains having a corresponding carrier (shown as the Carrier 1 and Carrier 2). In the first NCSG mode, a gap may need to be scheduled on the RF1 chain when the UE performs a measurement object (MO) on the RF2 chain. The UE cannot maintain data transmission on the RF1 chain while performing the MO on the RF2 chain. This may be caused by the UE's limited capability for maintaining two RF chains. For example, certain radio elements of the UE may not be able to support two concurrent RF1 and RF2 chains. As such, the UE has to put a gap on the RF1 chain and switch to the RF2 chain for the MO. Since the first type of NCSG mode has a gap scheduled on the RF1 chain, it may be indicated with a support indicator that has a value of “gap” in the NCSG support information. The first type of NCSG mode may also be referred to as a measurement gap mode. The measurement gap mode is a legacy mode that makes the least use of UE's support capability of NCSG. NCSG configuration for this measurement gap mode may also be referred to as measurement gap configuration.

FIG. 4B illustrates a second type of NCSG mode according to embodiments disclosed herein. Like the example of FIG. 4A, two RF chains (shown as the RF1 and RF2 chains) are shown, each RF chains having a corresponding carrier (shown as the Carrier 1 and Carrier 2). In the second type of NCSG mode, a gap may not need to be scheduled on the RF1 chain when the UE performs a MO on the RF2 chain. The UE can maintain the RF1 chain for data transmission while performing the MO on the RF2 chain. However, one or more short interruptions may be scheduled on the RF1 chain. The interruptions may be scheduled at the time when the MO starts and/or ends on the RF2 chain. Such interruptions may allow the UE to prepare and/or exit support of two concurrent RF1 and RF2 chains. The preparation and/or exit may require, for example, adjusting certain radio elements of the UE. Each of the interruptions is shown with a visible interruption length (VIL). The VIL may be configurable. The second type of NCSG mode may be indicated with a support indicator that has a value of “ncsg” in the NCSG support information.

FIG. 4C illustrates a third type of NCSG mode according to embodiments disclosed herein. Like the examples of FIGS. 4A and 4B, two RF chains (shown as the RF1 and RF2 chains) are shown, each RF chains having a corresponding carrier (shown as the Carrier 1 and Carrier 2). In the third type of NCSG mode, a gap may not need to be scheduled on the RF1 chain when the UE performs the MO on the RF2 chain. In addition, one or more interruptions may not be scheduled on the RF1 chain when the MO starts and/or ends on the RF2 chain. This may be caused by the fact that UE has sufficient capability to enter and/or exit support of two concurrent RF1 and RF2 chains without transmission interruptions on the RF1 chain. The third NCSG mode may be indicated with a support indicator that has a value of “nogap-noncsg” in the NCSG support information.

The second type of NCSG mode avoids a relatively long transmission gap on the RF1 chain, so it may be more desirable than the first type of NCSG mode. Likewise, the third NCSG mode also avoids a relatively long transmission gap on the RF1 chain, so it may be more desirable than the first type of NCSG mode. In addition to that, the third NCSG mode avoids short transmission interruptions on the RF1 chain, so it may also be more desirable than the second type of NCSG mode. The first type of NCSG mode is a legacy mode in the NCSG mechanism. The second type of NCSG mode is an advanced mode in the NCSG mechanism. The third type of NCSG mode is a further advanced mode in the NCSG mechanism.

It is appreciated that the NCSG modes of FIGS. 4A-4C are merely provided for illustrative purposes. Each of the NCSG modes may be indicated through any suitable value in the NCSG support information element, not limited to the “gap”, “ncsg” or “nogap-noncsg” values. Other types of NCSG modes may be developed in the future, which may be included without departing from the principle of the disclosure. In other embodiments, the UE may support more than two RF chains. In some embodiments, the RF1 chain and the RF2 chain may be within in a same frequency band, so the MO may be directed to intra-frequency measurement. In other embodiments, the RF1 chain and the RF2 chain may be in different frequency bands, so the MO may be directed to inter-frequency measurement.

Turning back to FIG. 3. At step 310, the network device may determine NCSG configuration for the UE. The NCSG configuration may be associated with a NCSG mode that is determined for each of the target bands. According to embodiments disclosed herein, the NCSG mode may be determined based on one or more specified conditions. In some embodiments, the one or more specified conditions may be associated with one or more additional information provided in the NCSG support information element. If the one or more specified conditions are satisfied, the NCSG mode that is reported by the UE in step 308 may be deemed valid. Accordingly, the NCSG configuration may be determined based on the reported NCSG mode of the UE. If the one or more specified conditions are not satisfied, the NCSG mode of the UE reported in step 308 may be deemed invalid. The NCSG configuration may be determined based on another NCSG mode that differs from the reported NCSG mode of the UE.

At step 312, the network device may transmit the determined NCSG configuration to the UE. The determined NCSG configuration may indicate which of NCSG modes will be used. For example, the determined NCSG configuration may indicate which of the first (“gap”), second (“ncsg”), or third (“nogap-noncsg”) types of NCSG modes is to be used for the UE. Additionally, the determined NCSG configuration may comprise one or more specified parameters associated with the NCSG mode to be used.

Additionally, the network device may transmit a MO to the UE. The MO may be associated with one or more measurements to be performed on the target band.

At step 314, the network device and the UE may perform the MO according to the determined NCSG configuration provided in step 312. For example, the UE and/or the network device may perform the MO according to the NCSG mode as indicated in the determined NCSG configuration, where one or more parameters associated with the NCSG mode are also specified in the NCSG configuration.

Conventional configuration and use of NCSG may not fully take advantage of a UE's support capability for NCSG, thereby jeopardizing benefits of the NCSG mechanism.

UE's support of a NCSG mode partially depends on whether there is a vacant RF chain. In some scenarios, the availability of vacant RF chains depends on how many SCells are in an active support mode. An activated SCell occupies one of vacant RF chains of the UE, while a deactivated SCell (even if it has been added for the UE) does not occupy a vacant RF chain of the UE. Hence, an activation status of one or more SCells may affect how many RF chains of the UE are vacant and available, thereby affecting UE's actual support of NCSG modes.

Unlike activation or deactivation of the one or more SCells that may be controlled dynamically (for example, through relatively dynamic MAC CE signaling), UE's support of NCSG modes is reported statically (for example, through relatively static RRC signaling) and is reported regardless whether the SCells are in an activated mode or a deactivated mode. Therefore, the UE may have to report a conservative NCSG mode, under an assumption that the related SCells are activated. The benefit of NCSG is therefore jeopardized when the related SCells are actually deactivated.

Another problem occurs when the SCell switches to the activated mode from the deactivated mode. At this time, since the NCSG mode is reported statically and regardless where and how large the active BWP is in the target band, there is possibility that the UE may lose its support of the reported NCSG mode if one or more active BWPs in the SCell cannot cover the MO on the target band. Considering this possibility, the UE may choose to report support of a conservative NCSG mode for the target band. For example, the UE may report that it only supports the first type of NCSG mode (“gap”) instead of the second NCSG (“ncsg”) NCSG mode on the target band. The chance of using the second type of NCSG mode (which is more desirable) to measure on the target band would be gone. The benefit of the NCSG mechanism is therefore jeopardized.

Embodiments contemplated herein provides enhancement on NCSG support, which allows for improved utilization and/or flexibility of NCSG.

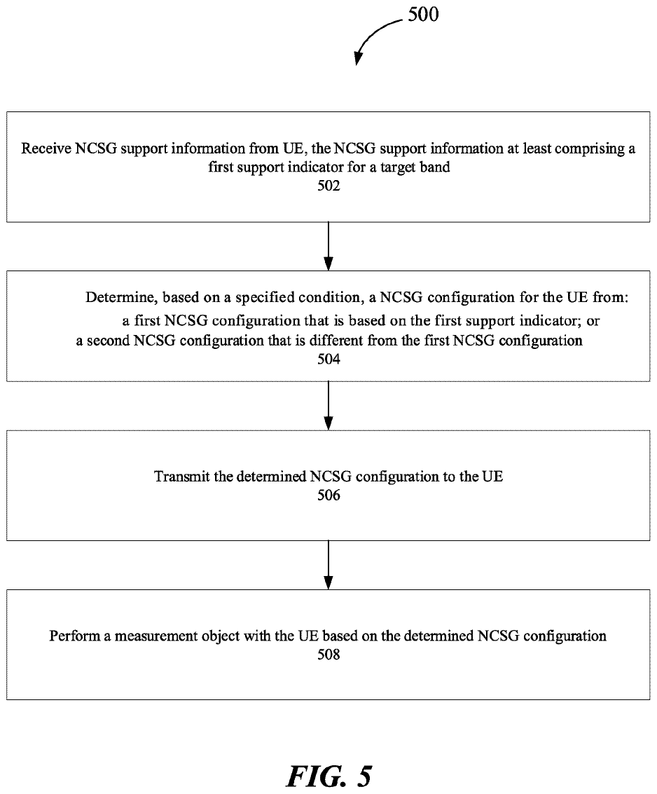

FIG. 5 illustrates an exemplary process 500 that implements enhancement on NCSG support according to embodiments disclosed herein. The process 500 may be performed by a network device or a processor/controller thereof. The network device may be implemented as an instance of the network device 218 of FIG. 2.

The process 500 may start at step 502, in which the network device may receive NCSG support information from a UE. The NCSG support information may at least includes a first support indicator for a target band. The first support indicator may be used to report the UE's support of a particular NCSG mode. The particular NCSG mode may be one of the NCSG modes of FIGS. 4A-4C, or any other suitable type of NCSG modes.

At step 504, the network device may determine, based on a specified condition, NCSG configuration for the UE. The NCSG configuration for the UE may be determined from a first NCSG configuration that is based on the first support indicator or a second NCSG configuration that is different from the first NCSG configuration. Depending on the specified condition, the determined NCSG configuration for the UE may be consistent with the particular NCSG mode indicated by the first support indicator in the NCSG support information or may be different from that particular NCSG mode. In other words, the particular NCSG mode is deemed valid when the specified condition is satisfied, or invalid when the specified condition is not satisfied.

According to some embodiments disclosed herein, the specified condition may be associated with an activation status of one or more SCells. According to alternative embodiments disclosed herein, the specified condition may be associated with a particular indication of NCSG support per BWP. The determination associated with different specified conditions will be discussed below with more details.

At step 506, the network device may transmit the determined NCSG configuration to the UE. The NCSG configuration may describe a NCSG mode to be used for the UE by one or more specified parameters associated with the NCSG mode.

At step 508, the network device may perform a MO with the UE based on the determined NCSG configuration. The MO may be specified by the network device. Various MO may be used. For example, the MO may include any of Single Side band (SSB) based measurement and/or Channel State Indication Reference Signal (CSI-RS) based measurement, such as measurements of Reference Signal Received Power (RSRP), Reference Signal Received Quality (RSRQ), Signal to Interference plus Noise Ratio of Reference Signal (RS-SINR), or the like. Other measurements may also be included in the MO in alternative embodiments.

As described above, the specified condition for determining the NCSG configuration may be associated with an activation status of one or more SCells. In some of these embodiments, the specified condition may be specifically associated with a number of SCells that are currently activated. The particular NCSG mode reported in the NCSG support information from the UE is deemed valid when the number of currently activated SCells falls within a specified range.

For example, a maximum number of activated SCells may be specified. This maximum number may describe a largest number of SCells that are allowed to be activated if the particular NCSG mode reported in the NCSG support information from the UE should be deemed valid. In these embodiments, the network device may compare the number of SCells that are currently activated with the specified maximum number of activated SCells. If the number of SCells that are activated is no larger than the specified maximum number, the network device may determine the first NCSG configuration as the NCSG configuration for the UE. That is, the particular NCSG mode as report by the first support indicator in the NCSG support information from the UE is deemed valid. Otherwise, if the number of SCells that are activated is larger than the specified maximum number, the network device may determine the second NCSG configuration as the NCSG configuration for the UE. That is, the particular NCSG mode reported in the NCSG support information from the UE is deemed invalid, and a second NCSG mode that is different from the particular NCSG mode should be used instead.

The maximum number of activated SCells may be specified in various ways. For example, the maximum number of activated SCells may be determined based on a maximum number of RF chains that the UE is able to concurrently support. As such, the maximum number of activated SCells may vary from one UE to another, depending on implementation of the UE.

In an embodiment, the maximum number of activated SCells may be specified by the network device. In a preferred embodiment, the maximum number of activated SCells may be specified and reported by the UE to the network device. The maximum number of activated SCells may be reported to the network device in various signaling. In a preferred embodiment, the maximum number of activated SCells may be included in the NCSG support information along with the first support indicator. As an example, an exemplary NCSG support information element containing the maximum number of activated SCells (shown in bold) is illustrated in Table 2.

TABLE 2
NCSG support information element

NeedForGapNCSG-InfoNR-r17 :: = SEQUENCE {

| | |
|---|---|
| intraFreq-needForNCSG-r17 | NeedForNCSG-IntraFreqList-r17, |
| interFreq-needForNCSG-r17 | NeedForNCSG-BandListNR-r17, |
| MaxActiveSCell-r17 | INTEGER (0...32) |

}
NeedForNCSG-IntraFreqList-r17 :: = SEQUENCE (SIZE (1..
maxNrofServingCells)) OF NeedForNCSG-IntraFreq-r17
NeedForNCSG-BandListNR-r17 :: = SEQUENCE (SIZE (1..maxBands)) OF
NeedForNCSG-NR-r17
NeedForNCSG-IntraFreq-r17 :: = SEQUENCE {

| | |
|---|---|
| servCellId-r17 | ServCellIndex, |
| gapIndicationIntra-r17 | ENUMERATED {gap, ncsg, nogap-noncsg} |

}

| | |
|---|---|
| NeedForNCSG-NR-r17 :: = | SEQUENCE { |
| bandNR-r17 | FreqBandIndicatorNR, |
| gapIndication-r17 | ENUMERATED {gap, ncsg, nogap-noncsg} |

}

As illustrated in Table 2, the NCSG support information element may additionally include a particular field (e.g., MaxActiveSCell-r17), of which the value indicates the specified maximum number of activated SCells. This particular field may be used to indicate that NCSG mode indicated by the first support indicator (e.g., in intraFreq-needForNCSG-r17 and/or interFreq-needForNCSG-r17) is valid as long as a number of currently activated SCells is no larger than the value of the particular field. In this example, the maximum number of activated SCells may have an integer value in a range of (0 . . . 32). In other embodiments, the range of possible maximum number of activated SCells may be different.

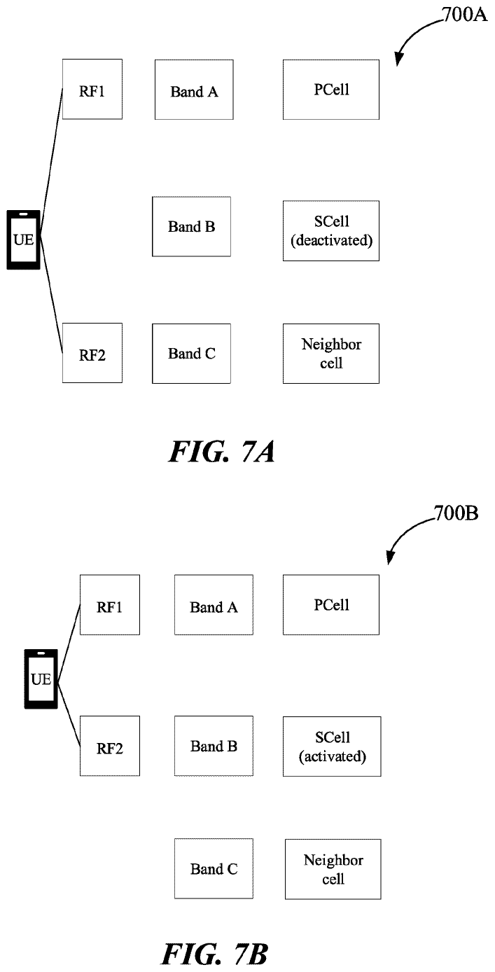

FIGS. 7A-7B illustrates exemplary scenarios 700A-700B in which a maximum number of activated SCells is specified according to embodiments disclosed herein. In the scenarios 700A-700B, the UE has two RF chains, one (RF1) of which has been occupied by the Primary Cell (PCell) on band A, and the other (RF2) may be vacant. The UE may specify the maximum number of activated SCells with a value of zero (0). Also, the UE may set the first support indicator for target band C with a value of “ncsg” in the NCSG support information, indicating support of the second type of NCSG mode. When a SCell is deactivated as shown in scenario 700A, a total number of currently activated SCells is zero, which is no larger than the specified maximum number (0) of activated SCells. Hence, the NCSG configuration determined for the UE may follow the first support indicator that is reported in the NCSG support information. Based on this NCSG configuration, the UE may perform a designated MO using the vacant RF chain (RF2) according to the second type of NCSG mode, which requires no transmission gaps on the RF1 chain (or, on the band A). If the SCell is activated, as shown in scenario 700B, the vacant RF2 chain may be occupied by the SCell, and the total number of currently activated SCells is one (1), exceeding the specified maximum number. So, the UE may not follow the first support indicator to perform according to the second type of NCSG mode. Instead, the UE may perform the MO on band C according to a different NCSG mode. The different NCSG mode may be a first type of NCSG mode (“gap”) as illustrated in FIG. 4A, which requires transmission gaps on the RF1 chain. As shown in scenarios 700A-700B, with the activation status of the SCell considered, the UE may be able to perform according to the second type of NCSG mode at least when the SCell remains deactivated. This improves utilization of NCSG support capability of the UE.

Note that the embodiment of FIGS. 7A-7B is merely for illustration but not for limitation. In other embodiments, there might be more than one SCell that is associated with the UE. Some of the SCells may have been activated while other may not. In other embodiments, there might be more bands associated with the UE other than the bands A, B and C. The UE may set the maximum number of activated SCells as a different value. Additionally, the UE may set the first support indicator as a different type of NCSG mode in the NCSG support information, such as the “nogap-noncsg” mode of FIG. 4C.

In additional or alternative embodiments, the specified condition for determining the NCSG configuration may be associated with whether one or more particular SCells are activated. In these embodiments, a list of the particular SCells may be specified. The network device may determine the activation status of SCells in the list and determine the NCSG configuration for the UE based on the determined activation status.

In a first one of these embodiments, the network device may determine the specified condition is satisfied when all SCells in the list of specified SCells are deactivated. Accordingly, the network device may determine the first NCSG configuration as the NCSG configuration for the UE. In this embodiment, the specified condition is determined as not satisfied when any SCell in the list of specified SCells is activated, leading the network device to determine the second NCSG configuration as the NCSG configuration for the UE.

In a second one of these embodiments, the network device may determine the specified condition is satisfied if any SCell in the list of specified SCells is deactivated. Accordingly, the network device may determine the first NCSG configuration as the NCSG configuration for the UE. In this embodiment, the specified condition is not satisfied when all SCells in the list of specified SCells are activated, leading the network device to determine the second NCSG configuration as the NCSG configuration for the UE.

In a third one of these embodiments, the network device may determine the specified condition is satisfied if a certain amount of SCells in the list of specified SCells is deactivated and the certain amount is above a threshold. Accordingly, the network device may determine the first NCSG configuration as the NCSG configuration for the UE.

The list of specified SCells may be specified in various ways. For example, the size of the list of specified SCells may be determined based on a maximum number of RF chains that the UE is able to concurrently support. As such, the list of specified SCells may vary from one UE to another. In addition, a particular SCell may be included or excluded in the list based on a relationship between the SCell and the target band. For example, if the UE has less trouble supporting a particular band associated with a particular SCell and the target band concurrently (for example, the particular band is far away from the target band), that particular SCell may be excluded from the list of specified SCells. If the UE might have trouble supporting the particular band and the target band concurrently (for example, the particular band may be close to the target band), that particular SCell may be included in the list of specified SCells. The list of specified SCells may further vary from one SCell to another (or, band to band).

In an embodiment, the list of specified SCells may be specified by the network device. In a preferred embodiment, the list of specified SCells may be specified by the UE and reported to the network device. The list of specified SCells may be reported to the network device in various signaling. In a preferred embodiment, the list of specified SCells may be included in the NCSG support information along with the first support indicator. As an example, an exemplary NCSG support information element containing the list of specified SCells (shown in bold) is illustrated in Table 3.

TABLE 3
NCSG support information element

NeedForGapNCSG-InfoNR-r17 :: = SEQUENCE {

| | |
|---|---|
| intraFreq-needForNCSG-r17 | NeedForNCSG-IntraFreqList-r17, |
| interFreq-needForNCSG-r17 | NeedForNCSG-BandListNR-r17, |

}
NeedForNCSG-IntraFreqList-r17 :: = SEQUENCE (SIZE (1..
maxNrofServingCells)) OF NeedForNCSG-IntraFreq-r17
NeedForNCSG-BandListNR-r17 :: = SEQUENCE (SIZE (1..maxBands)) OF
NeedForNCSG-NR-r17
NeedForNCSG-IntraFreq-r17 :: = SEQUENCE {

| | |
|---|---|
| servCellId-r17 | ServCellIndex, |
| gapIndicationIntra-r17 | ENUMERATED {gap, ncsg, nogap-noncsg} |

}

| | |
|---|---|
| NeedForNCSG-NR-r17 :: = | SEQUENCE { |
| bandNR-r17 | FreqBandIndicatorNR, |
| gapIndication-r17 | ENUMERATED {gap, ncsg, nogap-noncsg}, |

DeactivatedSCC-needForNCSG-r17 SEQUENCE {ServCellIndex_x,
ServCellIndex_x+1 ... maxNrofServingCells}
}

As illustrated in Table 3, the NCSG support information element may additionally include a particular field (e.g., DeactivatedSCC-needForNCSG-r17), of which the value indicates a list of specified SCells. Each SCell in the list may be identified by a corresponding identifier, such as ServCellIndex_x, ServCellIndex_x+1 . . . maxNrofServingCells. This particular field may be used to indicate that the NCSG mode corresponding to the associated first support indicator (e.g., interFreq-needForNCSG-r17, more specifically, gapIndication-r17 in interFreq-needForNCSG-r17) is valid as long as the activation status of SCells in the list satisfies the specified condition. The activation status of other SCells that are not included in the list may not be considered because they do not affect the validity of the associated first support indicator.

In additional or alternative embodiments, the specified condition for determining the NCSG configuration may be associated with one or more other factors. These factors may be used separately, together, or in combination with other factors, as needed.

In some embodiments, the specified condition may be associated with whether an associated SCell is activated. In these embodiments, the UE may report only the first support indicator for currently activated SCell(s). For currently deactivated SCell(s), the UE may report, in addition to the first support indicator, a second support indicator. The second support indicator may indicate the UE's support of a second NCSG mode when the SCell is deactivated. If the associated SCell remains deactivated, the network device may determine the specified condition is not satisfied (namely, the first support indicator is invalid). As such, the network device may determine the second NCSG configuration as the NCSG configuration for the UE. The second NCSG configuration may be based on the second NCSG mode. If the associated SCell gets activated, the network device may determine the specified condition is satisfied (namely, the first support indicator is valid). As such, the network device may determine the first NCSG configuration as the NCSG configuration for the UE. The first NCSG configuration is based on the first NCSG mode of the UE.

An exemplary NCSG support information element containing the second support indicator (shown in bold) is illustrated in Table 4.

TABLE 4
NCSG support information element

NeedForGapNCSG-InfoNR-r17 :: = SEQUENCE {

| | |
|---|---|
| intraFreq-needForNCSG-r17 | NeedForNCSG-IntraFreqList-r17, |
| interFreq-needForNCSG-r17 | NeedForNCSG-BandListNR-r17, |

}
NeedForNCSG-IntraFreqList-r17 :: = SEQUENCE (SIZE (1..
maxNrofServingCells)) OF NeedForNCSG-IntraFreq-r17
NeedForNCSG-BandListNR-r17 :: = SEQUENCE (SIZE (1..maxBands)) OF
NeedForNCSG-NR-r17
NeedForNCSG-IntraFreq-r17 :: = SEQUENCE {

| | |
|---|---|
| servCellId-r17 | ServCellIndex, |
| gapIndicationIntra-r17 | ENUMERATED {gap, ncsg, nogap-noncsg |

```
    },
    DeactivatedSCC-needForNCSG-r17 ENUMERATED {gap, ncsg, nogap-
noncsg},
}
```

| | |
|---|---|
| NeedForNCSG-NR-r17 :: = | SEQUENCE { |
| bandNR-r17 | FreqBandIndicatorNR, |
| gapIndication-r17 | ENUMERATED {gap, ncsg, nogap-noncsg, |

}}
}

As illustrated in Table 4, the NCSG support information element additionally includes a particular field (e.g., DeactivatedSCC-needForNCSG-r17), which serves as the second support indicator. Like the first support indicator (e.g., gapIndicationIntra-r17), the value of the second support indicator may be selected from the set of enumerated values of {gap, ncsg, nogap-noncsg}. If a SCell indicated by an identifier (e.g., ServCellIndex) is activated, the first NCSG configuration associated with the first support indicator may be determined to be used for the UE. If said each SCell is deactivated, the second NCSG configuration associated with the second support indicator may be determined to be used for the UE.

In an alternative embodiment, the UE may include the first support indicator and the second support indicator for each associated SCell regardless of whether the associated SCell is activated or deactivated. The first support indicator may correspond to the first NCSG configuration that the UE supports when the associated SCell is activated. The second support indicator may correspond to the second NCSG configuration that the UE supports when the associated SCell is deactivated. The network device may determine which of the first NCSG configuration or the second NCSG configuration is to be used for the UE, depending on whether the associated SCell is actually activated.

In alternative embodiments, instead of the second support indicator, an applicable indication parameter may be provided in the NCSG support information. In these embodiments, the applicable indication parameter may be used to indicate whether the first support indicator is valid only if an associated SCell is deactivated. For example, the applicable indication parameter may have a first value, thereby indicating that the first support indicator is valid only when the associated SCell is deactivated. If the applicable indication parameter has the first value and an associated SCell is deactivated, the network device may determine the first support indicator is valid. Accordingly, the network device may determine the first NCSG configuration as the NCSG configuration for the UE. If the applicable indication parameter has the first value and the associated SCell is activated, the network device may determine the first support indicator is invalid. Accordingly, the network device may determine the second NCSG configuration as the NCSG configuration for the UE. If the applicable indication parameter has a second value different from the first value, the network device may determine the validity of the first support indicator is not based on the activation status of the associated SCell. In this case, the network device may determine the first support indicator is valid. Accordingly, the first NCSG configuration may be determined as the NCSG configuration for the UE regardless of whether the associated SCell is activated or deactivated.

An exemplary NCSG support information element containing the applicable indication parameter (shown in bold) is illustrated in Table 5.

TABLE 5
NCSG support information element

NeedForGapNCSG-InfoNR-r17 :: = SEQUENCE {

| | |
|---|---|
| intraFreq-needForNCSG-r17 | NeedForNCSG-IntraFreqList-r17, |
| interFreq-needForNCSG-r17 | NeedForNCSG-BandListNR-r17, |

}
NeedForNCSG-IntraFreqList-r17 :: = SEQUENCE (SIZE (1..
maxNrofServingCells)) OF NeedForNCSG-IntraFreq-r17
NeedForNCSG-BandListNR-r17 :: = SEQUENCE (SIZE (1..maxBands)) OF
NeedForNCSG-NR-r17
NeedForNCSG-IntraFreq-r17 :: = SEQUENCE {

| | |
|---|---|
| servCellId-r17 | ServCellIndex, |
| gapIndicationIntra-r17 | ENUMERATED {gap, ncsg, nogap-noncsg}, |

DeactivatedSCC-needForNCSG-r17 ENUMERATED {true, false},
}

| | |
|---|---|
| NeedForNCSG-NR-r17 :: = | SEQUENCE { |
| bandNR-r17 | FreqBandIndicatorNR, |
| gapIndication-r17 | ENUMERATED {gap, ncsg, nogap-noncsg} |

}
}

As illustrated in Table 5, the NCSG support information element additionally includes a particular field (e.g., DeactivatedSCC-needForNCSG-r17), which serves as the applicable indication parameter associated with validity of the first support indicator (e.g., gapIndicationIntra-r17). In this example, the applicable indication parameter is implemented as a Boolean parameter, of which the value of “true” indicates that the first support indicator is valid only if an associated SCell is deactivated, and the value of “false” indicates the validity of the first support indicator is not based on the activation status of the associated SCell. It is understood that the applicable indication parameter may be implemented as another type of variable with other possible values in alternative embodiments.

As described above, the specified condition may alternatively be associated with a particular indication of NCSG support per bandwidth part (BWP). In these embodiments, the first support indicator in the NCSG support information may indicate the UE's support of a NCSG mode per frequency band. For a frequency band spanning across multiple BWPs, if desired, the UE may additionally configure a particular indication of NCSG support per BWP in the NCSG support information. In this case, the network device, after receiving the NCSG support information from the UE, may determine whether the particular indication of NCSG support per BWP is configured in the received NCSG support information. If the particular indication of NCSG support per BWP is not configured in the NCSG support information, the network device may determine the first NCSG configuration as the NCSG configuration for the UE. Otherwise, if the particular indication of NCSG support per BWP is configured in the NCSG support information, the network device may determine the second NCSG configuration as the NCSG configuration for the UE. The second NCSG mode may be based on the particular indication of NCSG support per BWP.

An exemplary NCSG support information element containing the particular indication of NCSG support per BWP (shown in bold) is illustrated in Table 6.

TABLE 6
NCSG support information element

NeedForGapNCSG-InfoNR-r17 :: = SEQUENCE {

| | |
|---|---|
| intraFreq-needForNCSG-r17 | NeedForNCSG-IntraFreqList-r17, |
| interFreq-needForNCSG-r17 | NeedForNCSG-BandListNR-r17, |

}
NeedForNCSG-IntraFreqList-r17 :: = SEQUENCE (SIZE (1..
maxNrofServingCells)) OF NeedForNCSG-IntraFreq-r17
NeedForNCSG-BandListNR-r17 :: = SEQUENCE (SIZE (1..maxBands)) OF
NeedForNCSG-NR-r17
NeedForNCSG-IntraFreq-r17 :: = SEQUENCE {

| | |
|---|---|
| servCellId-r17 | ServCellIndex, |
| gapIndicationIntra-r17 | ENUMERATED {gap, ncsg, nogap-noncsg}, |
| BWP-indication | SEQUENCE (SIZE (Y)) OF gapIndicationBWP. |

- - - - optional
}

| | |
|---|---|
| NeedForNCSG-NR-r17 :: | = SEQUENCE { |
| bandNR-r17 | FreqBandIndicatorNR, |
| gapIndication-r17 | ENUMERATED {gap, ncsg, nogap-noncsg}} |

}
gapIndicationBWP :: = SEQUENCE {

| | |
|---|---|
| BWPID | BWP-ID, |
| gapIndication_BWP | ENUMERATED {gap, ncsg, nogap-noncsg} |

}

As illustrated in Table 6, the NCSG support information element additionally includes a particular field (e.g., BWP-indication), which serves as the particular indication of NCSG support per BWP. Parameter Y may represent a maximum allowed number of BWPs that can be configured per cell. An indication (e.g., gapIndication_BWP) for the reported NCSG mode for each BWP (indicated by BWP-ID) may be selected from the set of enumerated values of {gap, ncsg, nogap-noncsg}. This particular field may be optional. For example, only UEs with sufficient capability to support NCSG per BWP may configure and include the particular field in the NCSG support information. Accordingly, if the particular field is not found in the NCSG support information received from the UE, the network device may determine to follow the first support indicator (e.g., gapIndicationIntra-r17) that is configured per band (related to servCellId-r17). If the particular field is provided in the NCSG support information received from the UE, the network device may ignore the first support indicator (e.g., gapIndicationIntra-r17) that is configured per band (related to servCellId-r17) and determine to follow the support indicators that are configured per BWP in that particular field.

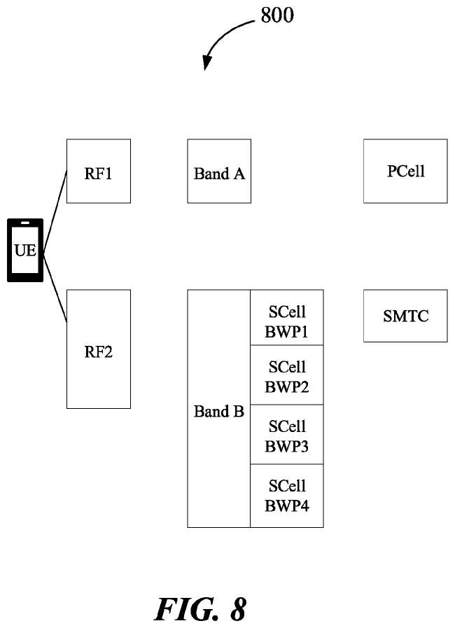

FIG. 8 illustrates an exemplary scenario 800 in which a particular indication of NCSG support per BWP is used according to embodiments disclosed herein. In this scenario, the UE has two RF chains, one (RF1) of which has been occupied by the Primary Cell (PCell) and is on band A, and the other (RF2) may support a range of two active BWPs (BWP1-BWP2) on band B. Band B is shown as spanning across four BWPs (BWP1-BWP4). A measurement object is to be performed on band B. When receiving an inquiry of NCSG support for band B, the UE may set the first support indicator based on a relatively conservative support mode (for example, the first type of NCSG mode, “gap”). For a particular measurement object that occurs within BWP1-BWP2, the UE may additionally include a particular indication of NCSG support per BWP in the NCSG support information. This particular indication of NCSG support per BWP may indicate a less conservative support mode (for example, the second type of NCSG mode of “ncsg” or the third type of NCSG mode of “nogap-noncsg”) for at least BWP1 and BWP2. For that particular measurement object, the network device may provide the second NCSG configuration for the UE, which is based on the less conservative support mode. This method provides UE's NCSG support on the BWP level, thereby improving utilization of NCSG support capability of the UE.

According to embodiments disclosed herein, the network device may also flexibly transition to an alternative NCSG configuration if a change of validity of the NCSG configuration occurs. During the transition, transmission of the alternative NCSG configuration like step 506 may be omitted for saving communication overhead.

Specifically, the network device may detect whether a change of validity of a current NCSG configuration occurs. The current NCSG configuration may be the determined NCSG configuration of step 504. As discussed above, the validity of the NCSG configuration may rely on one or more specified conditions, which may be affected by one or more factors including an activation status of one or more SCell or whether the MO is able to be covered in one or more active BWPs. A change of validity of the current NCSG configuration may occur upon SCell activation/deactivation, BWP transitioning and/or other operations. For example, due to SCell activation/deactivation, BWP transitioning and/or other operations, the MO on the target band may not be covered by the active BWP(s) of the SCell, or the MO may have different SCS with than PDSCH/PDCCH of the SCell and the UE does not support simultaneousRxDataSSB-DiffNumerology. In these conditions, the current NCSG configuration may no longer be feasible for the MO. Accordingly, the network device may determine that the current NCSG configuration has become invalid.

In response to detection that a change of validity of the current NCSG configuration has occurred, the network device may automatically transition to the alternative NCSG configuration, without transmitting the alternative NCSG configuration to the UE. In preferred embodiments, the alternative NCSG configuration may be a measurement gap configuration that corresponds to the measurement gap mode of FIG. 4A.

In one embodiment, the network device may automatically transition to the alternative NCSG configuration by transitioning to a predetermined measurement gap configuration. Various predetermined measurement gap configurations may be used in different embodiments. For example, one possible predetermined measurement gap configurations may include a legacy NCSG pattern (such as Gap Pattern #0) that is defined in Table 7. Other predetermined measurement gap configurations may also be used without limitation. The predetermined measurement gap configuration may be known to the network and the UE in advance, reducing communication overhead associated with transmission of the alternative NCSG configuration.

TABLE 7

| | | Measurement Gap |
|---|---|---|
| Gap | Measurement Gap | Repetition Period |
| Pattern Id | Length (MGL, ms) | (MGRP, ms) |
| 0 | 6 | 40 |
| 1 | 6 | 80 |
| 2 | 3 | 40 |
| 3 | 3 | 80 |
| 4 | 6 | 20 |
| 5 | 6 | 160 |
| 6 | 4 | 20 |
| 7 | 4 | 40 |
| 8 | 4 | 80 |
| 9 | 4 | 160 |
| 10 | 3 | 20 |
| 11 | 3 | 160 |
| 12 | 5.5 | 20 |
| 13 | 5.5 | 40 |
| 14 | 5.5 | 80 |
| 15 | 5.5 | 160 |
| 16 | 3.5 | 20 |
| 17 | 3.5 | 40 |
| 18 | 3.5 | 80 |
| 19 | 3.5 | 160 |
| 20 | 1.5 | 20 |
| 21 | 1.5 | 40 |
| 22 | 1.5 | 80 |
| 23 | 1.5 | 160 |
| 24 | 10 | 80 |
| 25 | 20 | 160 |

In another embodiment, the network device may automatically transition to the alternative NCSG configuration by copying values of one or more parameters of the current NCSG configuration to values of one or more corresponding parameters of an alternative measurement gap configuration and transitioning to the measurement gap configuration. For example, although the measurement gap configuration will have a measurement gap mode other than that of the current NCSG configuration (such as the mode in FIG. 4A vs the mode in FIG. 4B), the measurement gap configuration may have same values as the current NCSG configuration for parameters such as gap offset, measurement gap length (represented by MGL for the measurement gap mode, ML for the second type of NCSG mode), measurement gap repetition periodicity (MGRP for the measurement gap mode, VIRP for the second type of NCSG mode), measurement gap timing advance (MGTA). Copying of parameters values may be performed locally, reducing communication overhead associated with transmission of the alternative measurement gap configuration.

In some scenarios, the current NCSG configuration may correspond to the first NCSG configuration while the alternative NCSG configuration may correspond to the second NCSG configuration. For example, in an embodiment where a specified maximum number of activated Scells is used as the specific condition, the first NCSG configuration corresponding to the first support indicator reported in the NCSG support information may be initially used, because a total number of activated SCells is no larger than the specified maximum number. Due to activation of one or more SCells, the total number of activated SCells may become larger than the specified maximum number, leaving the first NCSG configuration no longer feasible. As such, the second NCSG configuration may be used as the alternative NCSG configuration. The second NCSG configuration may be a more conservative NCSG configuration than the first NCSG configuration, which is feasible under the changed situation.

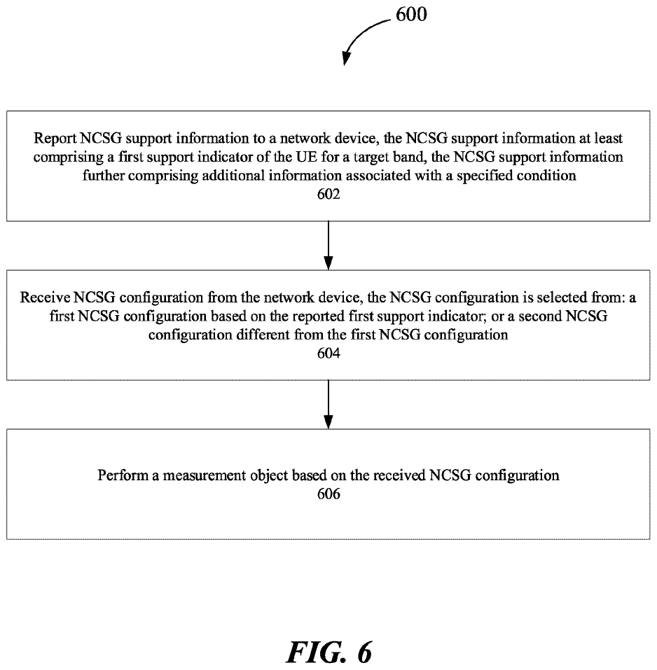

FIG. 6 illustrates an exemplary process 600 that implements enhancement on NCSG support according to embodiments disclosed herein. The process 600 may be performed by a UE or a processor/controller thereof. The UE may be implemented as an instance of the wireless device 202 of FIG. 2.

The process 600 may start at step 602, in which the UE may report NCSG support information to a network device. The NCSG support information may at least comprises a first support indicator for a target band. The first support indicator may be used to report the UE's support of a particular NCSG mode. The particular NCSG mode may correspond one of the NCSG modes of FIGS. 4A-4C, or any other suitable type of NCSG modes.

According to some embodiments, the NCSG support information may further comprise additional information associated with a specified condition. The specified condition may be associated with an activation status of one or more SCells. According to alternative embodiments disclosed herein, the specified condition may be associated with a particular indication of NCSG support per bandwidth part (BWP). Various specified conditions have been discussed above with details.

At step 604, the UE may receive NCSG configuration from the network device. The NCSG configuration may be selected from a first NCSG configuration based on the reported first support indicator or a second NCSG configuration different from the first NCSG configuration. The selection may be based on the specified condition. Determination of the NCSG configuration based on the specified condition have been discussed above with details.

At step 606, the UE may perform a MO based on the received NCSG configuration. Additionally, in response to a change of validity of the received NCSG configuration, the UE may automatically transition to an alternative NCSG configuration to perform the MO without receiving the alternative NCSG configuration from the network device. In preferred embodiments, the alternative NCSG configuration may be a measurement gap configuration. In some of the embodiments, the UE may transition to a predetermined measurement gap configuration that serves as the alternative NCSG configuration and is known to both of the UE and the network device. In another embodiment, the UE may copy values of one or more parameters of the received NCSG configuration to values of one or more corresponding parameters of a measurement gap configuration and transitioning to that measurement gap configuration.

As described above, various specified conditions may be used to determine the NCSG configuration for the UE. Accordingly, the additional information may include various parameters or values, as shown in Tables above.

In some embodiments, the additional information associated with the specified condition may include a specified maximum number of activated Scells. If a number of Scells that are activated is no larger than the specified maximum number of activated Scells, the received NCSG configuration may be the first NCSG configuration. If the number of Scells that are activated is larger than the specified maximum number of activated Scells, the received NCSG configuration may be the second NCSG configuration.

In some embodiments, the additional information associated with the specified condition may include a list of specified Scells. The specified condition is associated with an activation status of one or more Scells in the list of specified Scells. In a first one of these embodiments, the specified condition is satisfied when all SCells in the list of specified SCells are deactivated. In a second one of these embodiments, the specified condition is satisfied if any SCell in the list of specified SCells is deactivated. In a third one of these embodiments, the specified condition is satisfied if a certain amount of SCells in the list of specified SCells is deactivated and the certain amount is above a threshold. The NCSG configuration received by the UE may be the first NCSG configuration when the specified condition is satisfied. Otherwise, the NCSG configuration received by the UE may be the second NCSG configuration.

In some embodiments, the additional information associated with the specified condition may include an applicable indication parameter. The UE may specify the value of the applicable indication parameter, thereby indicating whether the first support indicator is valid if an associated SCell is deactivated. If the applicable indication parameter has a first value and an associated SCell is deactivated, the received NCSG configuration for the UE may be the first NCSG configuration corresponding to the first support indicator. If the applicable indication parameter has the first value and the associated SCell is activated, the received NCSG configuration for the UE may be the second NCSG configuration.

In these embodiments, the second NCSG configuration may be a more conservative configuration than the first NCSG configuration. In other words, the second NCSG configuration may have a poor utilization of the UE's support capability as compared to the first NCSG configuration. In some examples, the second NCSG configuration may require a scheduled transmission gap that is not required by the first NCSG configuration. For example, the second NCSG configuration may be based on the first type of NCSG mode illustrated in FIG. 4A, while the first NCSG configuration may be based on the second type of NCSG mode illustrated in FIG. 4B or the third type of NCSG mode illustrated in FIG. 4C. In this manner, when receiving an inquiry of NCSG support from the network, the UE may report a less conservative NCSG mode via the first support indicator. The less conservative NCSG mode could be used in certain scenarios (which are based on the specified condition), thereby maximizing utilization of the UE's support capability for NCSG. In response to a change of validity of the NCSG configuration that changes validity of the first NCSG configuration, the UE and the network may automatically transition from the less conservative NCSG mode to the more conservative NCSG mode.

In some embodiments, in addition to the first support indicator, the NCSG support information may include a second support indicator that is associated with the second NCSG configuration. If an associated SCell is activated, the received NCSG configuration may be the first NCSG configuration. If the associated SCell is deactivated, the received NCSG configuration may be the second NCSG configuration. In a preferred embodiment, second support indicator is reported as an addition only for a SCell that is currently deactivated. In these embodiments, the first NCSG configuration may be a more conservative configuration than the second NCSG configuration.

According to some embodiments, the UE may determine whether to configure a particular indication of NCSG support per bandwidth part (BWP) in the NCSG support information. The determination may be made based on how many active BWPs are located within the target band, and/or how large these BWPs are. In response to a determination not to configure the particular indication of NCSG support per BWP in the NCSG support information, the received NCSG configuration may be the first NCSG configuration that is based on UE's support of a NCSG mode per band. In response to a determination to configure the particular indication of NCSG support per BWP in the NCSG support information, the received NCSG configuration is the second NCSG configuration that is based on the particular indication of NCSG support per BWP.

Embodiments contemplated herein include an apparatus comprising means to perform one or more elements of the method 600. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method 600. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method 600. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method 600. This apparatus may be, for example, an apparatus of a UE (such as a wireless device 202 that is a UE, as described herein).

Embodiments contemplated herein include a signal as described in or related to one or more elements of the method 600.

Embodiments contemplated herein include a computer program or computer program product comprising instructions, wherein execution of the program by a processor is to cause the processor to carry out one or more elements of the method 600. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the method 500. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method 500. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method 500. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method 500. This apparatus may be, for example, an apparatus of a base station (such as a network device 218 that is a base station, as described herein).

Embodiments contemplated herein include a signal as described in or related to one or more elements of the method 500.

Embodiments contemplated herein include a computer program or computer program product comprising instructions, wherein execution of the program by a processing element is to cause the processing element to carry out one or more elements of the method 500. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

Embodiments contemplated herein provides enhancement on NCSG support. The configured NCSG configuration may depend on one or more specified conditions associating with various factors. The enhancement on NCSG support provides improved utilization and/or flexibility of NCSG.

For one or more embodiments, at least one of the components set forth in one or more of the preceding figures may perform one or more operations, techniques, processes, and/or methods as set forth herein. For example, a baseband processor as described herein in connection with one or more of the preceding figures may operate in accordance with one or more of the examples set forth herein. For another example, circuitry associated with a UE, base station, network element, etc. as described above in connection with one or more of the preceding figures may operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A network device, comprising:
at least one antenna;
at least one radio coupled to the at least one antenna; and
a processor coupled to the at least one radio;
wherein the processor is configured to:
receive Network Controlled Small Gap (NCSG) support information from a user equipment (UE), the NCSG support information at least comprising a first support indicator for a target band;
determine, based on a specified condition, a NCSG configuration for the UE from:
a first NCSG configuration that is based on the first support indicator; or
a second NCSG configuration that is different from the first NCSG configuration;
transmit the determined NCSG configuration to the UE; and
perform a measurement object with the UE based on the determined NCSG configuration.

2. The network device of claim 1, wherein the specified condition is associated with an activation status of one or more Secondary Cells (Scells).

3. The network device of claim 2, wherein the processor is configured to determine the NCSG configuration by:
if a number of Scells that are activated is no larger than a specified maximum number of activated Scells, determining the first NCSG configuration as the NCSG configuration for the UE; and
if the number of Scells that are activated is larger than the specified maximum number of activated Scells, determining the second NCSG configuration as the NCSG configuration for the UE.

4. The network device of claim 3, wherein the specified maximum number of activated Scells is included in the NCSG support information received from the UE.

5. The network device of claim 2, wherein the NCSG support information received from the UE further comprises information associated with a list of Scells, and wherein the processor is configured to determine the NCSG configuration based on the activation status of one or more Scells in the list of specified Scells.

6. The network device of claim 2, wherein the NCSG support information received from the UE further comprises a second support indicator associated with the second NCSG configuration, and wherein processor is configured to determine the NCSG configuration by:
if an associated Scell is activated, determining the first NCSG configuration as the NCSG configuration for the UE; and
if the associated SCell is deactivated, determining the second NCSG configuration as the NCSG configuration for the UE.

7. The network device of claim 2, wherein the NCSG support information received from the UE further comprises an applicable indication parameter, and wherein the processor is configured to determine the NCSG configuration by:
if the applicable indication parameter has a first value and an associated SCell is deactivated, determining the first NCSG configuration as the NCSG configuration for the UE;
if the applicable indication parameter has the first value and the associated SCell is activated, determining the second NCSG configuration as the NCSG configuration for the UE.

8. The network device of claim 1, wherein the specified condition is associated with a particular indication of NCSG support per bandwidth part (BWP), and wherein the processor is configured to determine the NCSG configuration by:
if the particular indication of NCSG support per BWP is not configured in the NCSG support information, determining the first NCSG configuration as the NCSG configuration for the UE; and
if the particular indication of NCSG support per BWP is configured in the NCSG support information, determining the second NCSG configuration as the NCSG configuration for the UE, the second NCSG configuration being based on the particular indication of NCSG support per BWP.

9. The network device of claim 2, wherein the processor is further configured to:
in response to a change of validity of the determined NCSG configuration, automatically transition to an alternative NCSG configuration, without transmitting the alternative NCSG configuration to the UE.

10. The network device of claim 9, wherein the processor is configured to automatically transition to the alternative NCSG configuration by at least one of:
transitioning to a predetermined measurement gap configuration; or
copying values of one or more parameters of the determined NCSG configuration to values of one or more corresponding parameters of an measurement gap configuration and transitioning to the measurement gap configuration.

11. A user equipment (UE), comprising:
at least one antenna;
at least one radio coupled to the at least one antenna; and
a processor coupled to the at least one radio;
wherein the processor is configured to:
report Network Controlled Small Gap (NCSG) support information to a network device, the NCSG support information at least comprising a first support indicator of the UE for a target band, the NCSG support information further comprising additional information associated with a specified condition;
receive NCSG configuration from the network device, the NCSG configuration being selected from:
a first NCSG configuration based on the reported first support indicator; or
a second NCSG configuration different from the first NCSG configuration; and
perform a measurement object based on the received NCSG configuration.

12. The UE of claim 11, wherein the specified condition is associated with an activation status of one or more Secondary Cells (Scells).

13. The UE of claim 12, wherein the second NCSG configuration requires a scheduled transmission gap that is not required by the first NCSG configuration.

14. The UE of claim 12, wherein the additional information associated with the specified condition comprises a specified maximum number of activated Scells, and wherein:
if a number of Scells that are activated is no larger than the specified maximum number of activated Scells, the received NCSG configuration is the first NCSG configuration; and
if the number of Scells that are activated is larger than the specified maximum number of activated Scells, the received NCSG configuration is the second NCSG configuration.

15. The UE of claim 12, wherein the additional information associated with the specified condition comprises a list of specified Scells, and wherein the specified condition is associated with an activation status of one or more Scells in the list of specified Scells.

16. The UE of claim 12, wherein the additional information associated with the specified condition comprises a second support indicator for the second NCSG configuration, and wherein:
if an associated Scell is activated, the received NCSG configuration is the first NCSG configuration; and
if the associated SCell is deactivated, the received NCSG configuration is the second NCSG configuration.

17. The UE of claim 12, wherein the additional information associated with the specified condition comprises an applicable indication parameter, the applicable indication parameter indicating whether the first support indicator is valid if an associated Scell is deactivated.

18. The UE of claim 11, wherein the processor is further configured to determine whether to configure a particular indication of NCSG support per bandwidth part (BWP) in the NCSG support information, and wherein:
in response to a determination not to configure the particular indication of NCSG support per BWP in the NCSG support information, the received NCSG configuration is the first NCSG configuration; and
in response to a determination to configure the particular indication of NCSG support per BWP in the NCSG support information, the received NCSG configuration is the second NCSG configuration that is based on the particular indication of NCSG support per BWP.

19. The UE of claim 11, wherein the processor is further configured to:
in response to a change of validity of the determined NCSG configuration, automatically transition to an alternative NCSG configuration, without receiving the alternative NCSG configuration from the network device.

20. The UE of claim 19, wherein the processor is configured to automatically transition to the alternative NCSG configuration by at least one of:
transitioning to a predetermined measurement gap configuration; or
copying values of one or more parameters of the received NCSG configuration to values of one or more corresponding parameters of a measurement gap configuration and transitioning to the measurement gap configuration.
